(19) United States
(12) Patent Application Publication
(10) Pub. No.: US 2015/0204523 A1
(43) Pub. Date: Jul. 23, 2015

(54) STRUCTURAL ELEMENT

(71) Applicant: Suomen Lasinjalostus Oy, Tampere (FI)

(72) Inventor: Emmi NIEMINEN, Tampere (FI)

(21) Appl. No.: 14/602,676

(22) Filed: Jan. 22, 2015

(30) Foreign Application Priority Data
Jan. 23, 2014 (RU) 2014102116

(51) Int. Cl. F21V 19/00; F21V 15/00; E04C 2/52; F21V 33/00; E04C 2/08; E04C 2/54

(52) U.S. Cl. CPC F21V 19/0015; E04C 2/08; E04C 2/54; E04C 2/526; F21V 33/006; F21V 15/00; F21W 2131/103

(57) ABSTRACT

Disclosed is a LED lamp structural element which can be used in road paving and cladding of buildings. The structural element has a body formed of a mixture of polymer and crushed glass, a stiffening member arranged within the body, and LED lamps are arranged on said stiffening member for illuminating the element body from within. The stiffening member increases flexural strength of the structural element.

### CROSS REFERENCE TO RELATED APPLICATION

This application claims the benefit under 35 U.S.C. §119 to Russian Utility Model Application No. 2014102116, filed on Jan. 23, 2014, the disclosure of which is incorporated herein by reference.

### FIELD OF THE INVENTION

The present invention relates to field of construction, in particular to a LED lamp structural element which can be used in road paving and cladding of buildings.

### BACKGROUND INFORMATION

Known are LED lamp structural elements made of a polymer with LED lamps (light-emitting diode) embedded therein. Such structural elements are widely used to decorate buildings. The disadvantage of said elements is low stiffness that prevents these elements from being used as paving stones for road paving, because applying a force to such structural element stretches the element body that can lead to permanent deformation of the light-emitting part, e.g. by severing the cable powering LED lamps. Further, known are LED lamp structural elements made of glass with LED lamps embedded therein. The disadvantage of such structural elements is increased fragility that narrows the range of potential applications. Furthermore, the high cost of such elements makes low-scale and medium-scale production thereof unfeasible.

The disadvantages of prior LED lamp structural elements were the reason for further improvements in the field. The Russian utility model No 129517 (filed on Jan. 31, 2013; IPC E01F9/00) discloses a luminescent structural element made of a polymer material which comprises a body formed of a polymer filled with crushed glass, and at least one LED lamp. The element further comprises an outer filling-free polymer layer, wherein the LED lamp is mounted on a conductive band placed within the polymer along the perimeter of the element at the level of the filling-free layer. The known element may be used outdoors in humid conditions and within a wide temperature range. However, said structural element has a number of disadvantages, including complex manufacturing due to the necessity of performing several technological operations spread over a period of time, particularly the successive manufacturing of the element body and the outer polymer layer. This disadvantage leads to an increase in manufacturing costs. Furthermore, said element tends to break if subjected to periodic load, caused e.g. by a vehicle wheel, along the interface between the element body and the outer layer, thus service life of the element is shortened.

The European patent EP2438250 (filed on Apr. 16, 2010; IPC E04C 2/54) discloses a structural workpiece considered to be prior art for the present application. Said structural workpiece has a body made of polymer filled with crushed glass, and a light-emitting part adapted to illuminate the workpiece body from within. The disadvantage of said workpiece is low workpiece body strength, and thus the workpiece body is prone to cracking.

### SUMMARY

Therefore, there is a need for a LED lamp structural element having sufficient strength and suitable to be widely used in road paving and building decoration.

This is achieved by providing the structural element disclosed in the present application, said structural element having a body comprising a polymer and crushed glass, and a light-emitting part adapted to illuminate the element body from within, the element is characterized in that it comprises at least one stiffening member arranged within the body, and the light-emitting part thereof is mounted at least partly on said stiffening member. Said stiffening member increases flexural strength of the structural element and provides greater resistance thereof to periodic load, thus decreasing the risk of the element body cracking.

According to one embodiment of the present application, the light-emitting part of the disclosed structural element comprises a conductive strip with LED's lamps evenly distributed thereon, the strip is arranged to be connected to a power supply by means of an electric cable, wherein the stiffening member comprises a metal plate with bent-up ends, the ends forming a bent-up portion of the plate, and the conductive strip extends along said bent-up portion of the plate. The plate can be a galvanized steel metal plate. The use of the plate as a stiffening member and a support for mounting LED lamps allows to significantly simplify manufacturing of the structural element and to reduce manufacturing costs. Furthermore, the plate forms a reflective surface that improves reflective properties of the structural element.

According to one particular embodiment, said stiffening member can have at least one grasp arranged to fix the electric cable providing the connection with the power source arranged outside the body. Said grasp allows decreasing the risk of severing the conductive strip from the cable at connection points thereof, and further allows transportation and use of structural elements without damaging said connection points.

According to one embodiment, the polymer makes from 20 to 30% of the body's volume and the crushed glass makes up the rest of the body's volume, i.e. 70-80% of the body's volume. Such volume ratio is optimal for providing structural element body strength.

The detailed description of preferred embodiments of the present structural element is further provided with reference to accompanying drawings.

### BRIEF DESCRIPTION OF THE DRAWINGS

FIG. 1 shows a perspective view of the structural element according to one embodiment, with a cutout made for clarity;

FIG. 2 shows a perspective view of the stiffening member according to the embodiment shown in FIG. 1;

FIG. 3 shows a bottom view of the stiffening member shown in FIG. 2.

### DETAILED DESCRIPTION

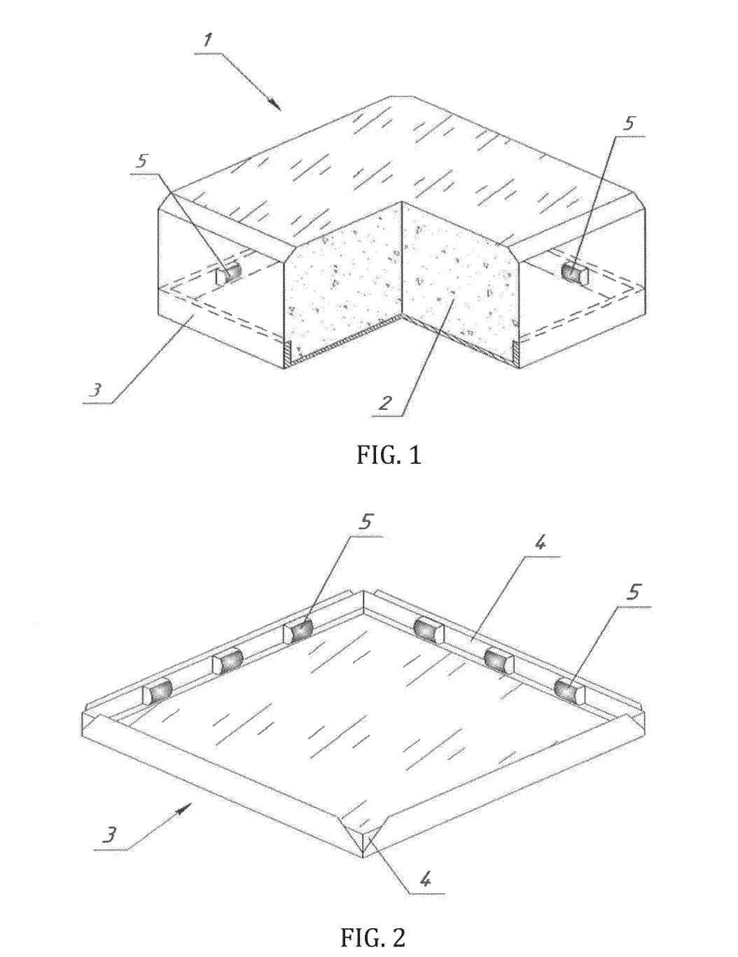

As shown in FIGS. 1-2, the disclosed structural element 1 has a body 1 made of a mixture of polymer and crushed glass. The polymer used is a transparent thermosetting resin with suitable hardness (e.g. Shore hardness D80), electrical insulation class (e.g. Electrical Insulation Class IEC216) and dielectric strength (e.g. 28 KV/mm-Dielectric Strength IEC 243). Crushed glass is predominantly formed by glass flakes with particle size from 3 to 7 mm. Preferably, the polymer makes from 20 to 30% of the body's 2 volume and the crushed glass makes the remaining 70 to 80% of the body's 2 volume. Body 2 has a parallelepiped shape.

Structural element 1 further comprises a stiffening member 3 arranged within the body 2. Said stiffening member 3 comprises a galvanized steel metal plate with its ends bent upwards, said ends forming a bent-up portion of the plate. Plate 3 preferably has a thickness of 0.5 mm. The stiffening member 3 is preferably positioned arranged at the base of the structural element 1 due to the element manufacturing process, wherein prior to supplying the polymer and crushed glass mixture, the member 3 is placed at the bottom of a pressing mold. Structural element 1 further comprises a light-emitting part providing illumination of the body 2 from within. The light-emitting part consists of a conductive strip 4 and LED lamps 5 evenly distributed along the strip 4. Strip 4 along with the LED lamps arranged thereon is mounted on the bent-up portion of the plate 3. Therefore, the plate 3 not only increases hardness of the body 2 and improves reflective properties of the element 1, but also allows uniform distribution of LED lamps within the body 2, thus providing uniform illumination and reflection of the light emitted by LED lamps 5. In addition to advantages described above, the plate increases thermal conductivity of the element 1, thus allowing for more intensive cooling of LED lamps 5, which significantly increases service life of LED lamps 5 and the element 1.

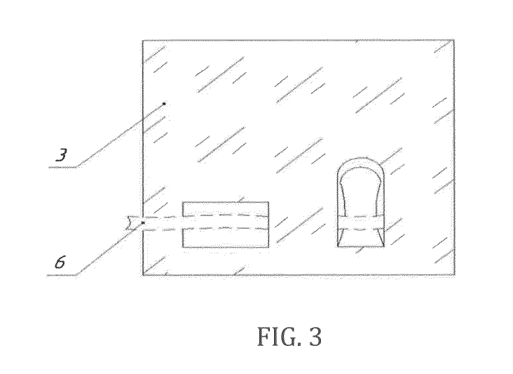

As shown in FIG. 3, LED lamps 5 are powered by an external power supply (not shown) via cable 6 that extends into the body 2 through an opening in the plate 3. The power source is an AC/DC converter that converts AC current (220 V) from a regular electrical power network into DC current (in 30-70 V range) and comprises a radiation intensity controller for the LED lamps 5. Plate 3 further comprises a grasp for fixing the cable 6 in a desired position. In the illustrated embodiment, the grasp is formed by a clamp cut from the material of plate 3 having an end connected to the plate 3. Several grasps can be provided, and said grasps can be arranged on any desired portion of the plate 3 at any required angle. In addition to advantages described hereinabove, the grasp allows for more convenient mounting due to the fact that the cable can be fixed in any convenient position.

To operate the structural element connected via the cable 6 to a power supply plugged into a regular electrical power network (220 V), the power unit must be turned on. Electrical current passing along the cable 6 reaches the conductive strip 4 with LED lamps 5 arranged thereon. The current passing through LED lamps 5 causes said LED lamps to generate optical radiation that illuminates the body of element 1 from within. The crushed glass and plate 3 reflect said radiation, thus forming a source of illumination. The uniformity of said illumination is provided by even distribution of the LED lamps 5. The radiation intensity of LED lamps 5 is provided by means of the radiation intensity controller for the LED lamps 5. While the detailed description of a specific preferred embodiment of the present structural element is provided hereinabove, it will be apparent to those skilled in the art, that various modifications of the element are possible. For instance, the shape of the element body can be rounded, and the stiffness member can be arranged or configured in various ways. A number of LED lamps (5), particularly one LED lamp, can be used. Furthermore, it will be apparent to those skilled in the art that several structural elements can be connected to one power source, and the order of structural element actuation can be predetermined by implementing an electrical wiring circuit, e.g. a series circuit or a parallel circuit.

Therefore, possible embodiments of the present structural element are not limited by the present description and the scope of the present application is limited solely by the appended claims.

1. A structural element having a body comprising a polymer and crushed glass, and a light-emitting part adapted to illuminate the body from within, the element is characterized in that it comprises at least one stiffening member arranged within the body and the light-emitting part is mounted at least partly on the stiffening member.

2. The structural element according to claim 1, wherein the light-emitting part comprises a conductive strip with at least one LED lamp arranged thereon, the strip is arranged to be connected to a power supply by means of an electric cable, wherein the stiffening member comprises a metal plate with bent-up ends, the ends forming a bent-up portion of the plate, and the conductive strip is mounted on the bent-up portion of the plate.

3. The structural element according to claim 2, wherein the stiffening member has at least one grasp arranged to fix the power cable providing the connection with the power source arranged outside the body.

4. The structural element according to claim 1, wherein the polymer makes from 20 to 30% of the body's volume and the crushed glass makes from 70 to 80% of the body's volume, respectively.

5. The structural element according to claim 2, wherein the metal plate is a galvanized steel metal plate.
